(19) United States
(12) Patent Application Publication
(10) Pub. No.: US 2019/0021547 A1
(43) Pub. Date: Jan. 24, 2019

(54) PAN WITH MEASURING MARKS

(71) Applicant: ZHEJIANG AISHIDA ELECTRIC CO., LTD., Zhejiang (CN)

(72) Inventor: Helin CHEN, Zhejiang (CN)

(21) Appl. No.: 16/032,518

(22) Filed: Jul. 11, 2018

(30) Foreign Application Priority Data
Jul. 24, 2017 (CN) 201720897410X

(51) Int. Cl. A47J 37/10

(52) U.S. Cl. CPC A47J 37/10; A47J 2203/00

(57) ABSTRACT

The present application relates to the technical field of pans and in particular relates to a pan with measuring marks. Aiming at the defect of the existing pan in the aspect of oil amount measurement, the adopted technical solution is as follow: a pan with measuring marks comprises a pan body and a pan handle mounted on the pan body; a first measuring mark is provided on a bottom surface of the pan body; a second measuring mark cooperatively used with the first measuring mark is provided on an inner sidewall of the pan body; and when the pan body is inclined, the measurement of oil amount is realized through the cooperative use of the first measuring mark and the second measuring mark. The present application can realize measurement by operating the pan handle only to enable the pan body to be inclined, and the operation is convenient to perform; and no measuring tool is needed to measure the oil amount, the oil amount can be relatively accurately controlled and the pan is simple and convenient to use.

### FIELD

The present application belongs to the technical field of pans and in particular relates to a pan with measuring marks.

### BACKGROUND

When a pan is used for cooking food, it is not easy to control an amount of oil poured into the pan. If the amount of oil is small, the cooking effect is not good; and if the amount of oil is excessive, waste is caused and it is not beneficial to body health of people. If the oil amount is measured by adopting a special measuring tool (such as a measuring cup, a measuring spoon or utensil), at each time when oil is poured, firstly the oil is poured into the measuring tool, then the oil is poured into the pan, the measuring tool needs to be cleaned after use and it is very troublesome in use. Therefore, many people pour oil directly based on feeling and usually the oil amount cannot be relatively accurately controlled.

In order to solve the above-mentioned problem, Chinese utility model patent with authorized publication No. CN 202146201U discloses a pan with scales, wherein scales indicating normal oil demands of human body are clearly marked at a bottom of the pan. The scales are provided at the bottom of the pan and are only applicable to round-bottom pans and are not suitable for flat-bottom pans, the limitation is great, the applicable scope is small and the specific numerical value of oil amount cannot be measured.

### SUMMARY

Aiming at the defects of the existing pan in the aspect of oil amount measurement, the present application provides a pan with measuring marks which are suitable for oil amount measurement of various pans.

In order to realize the above-mentioned purpose, the present application adopts the following technical solution: a pan with measuring marks comprises a pan body and a pan handle mounted on the pan body;

a first measuring mark is provided on a bottom surface of the pan body;

a second measuring mark cooperatively used with the first measuring mark is provided on an inner sidewall of the pan body; and

when the pan body is inclined, the measurement of oil amount is realized through the cooperative use of the first measuring mark and the second measuring mark.

Preferably, the number of the first measuring mark is one and the number of the second measuring mark is one. Since partial people strictly control oil amount per dish per day per meal at current, one pair of measuring marks are only provided such that people can be reminded of whether current oil amount exceeds an upper limit, and thus demands of partial people are met.

Preferably, the number of the first measuring mark is one and the number of the second measuring mark is more than one. Most people add a proper amount of oil according to different types of food and different amounts of food, and by providing one first measuring mark and a plurality of second measuring marks, various different oil amounts can be measured.

Preferably, the number of the first measuring mark is more than one and the number of the second measuring mark is one. Most people add a proper amount of oil according to different types of food and different amounts of food, and by providing a plurality of first measuring marks and one second measuring mark, various different oil amounts can be measured.

Preferably, the number of the first measuring mark is more than one and the number of the second measuring mark is more than one. Most people add a proper amount of oil according to different types of food and different amounts of food, and by providing a plurality of first measuring marks and a plurality of second measuring mark, various different oil amounts can be measured.

Preferably, the first measuring mark and the second measuring mark which are cooperatively used are provided with scale lines which are connected to form a ring, such that the observation is facilitated and rapid measurement can be realized.

Preferably, the first measuring mark and the second measuring mark are one or a combination of more of point, line, numeral, character and symbol. By providing various different marks for selection, differentiated demands of people are met.

Preferably, the first measuring mark and the second measuring mark are provided at a position, close to the pan handle, of the pan body, such that the operation and observation are facilitated. It is more difficult to incline the pan in a direction perpendicular to a left-right direction of the handle, and it is easier to incline the pan along the direction of the handle.

Preferably, the first measuring mark and the second measuring mark are provided at a position, far away from the pan handle, of the pan body, such that the operation and observation are facilitated. It is more difficult to incline the pan in a direction perpendicular to a left-right direction of the handle, and it is easier to incline the pan along the direction of the handle.

Preferably, the first measuring marks and the second measuring marks are provided at a position close to the pan handle and a position far away from the pan handle, such that the operation and observation are facilitated. It is more difficult to incline the pan in a direction perpendicular to a left-right direction of the handle, and it is easier to incline the pan along the direction of the handle. By providing the measuring marks at both ends, different use habits of people are met.

Preferably, the pan body is a flat-bottom circular pan body, the first measuring mark comprises a line segment, the second measuring mark comprises a plurality of arcs, planes on which the arcs are located are in parallel with one another and an Arabic numeral is provided at the position of each arc. When the oil amount is measured, after oil is in a horizontal state, the line segment at the bottom of the pan body and the arcs on the sidewall of the pan body are in flush with an oil surface, such that the measurement is more accurate. Since each arc is provided with an Arabic numeral, the observation is facilitated.

Preferably, the line segment and the arcs are formed by grooves on the pan body, the depth of each groove is smaller than or equal to 0.5 mm and the width of each groove is smaller than or equal to 0.5 mm. As compared with protrusions, it is convenient to manufacture grooves; and the depth of each groove shall be as small as possible on the premise that the observation need is met. If the depth of each groove is greater than 0.5 mm, the manufacturing time is long and the measurement accuracy is influenced; and if the width of each groove is greater than 0.5 mm, the manufacturing time is long and the measurement accuracy is influenced. The depth and width of the grooves have an allowance for the thickness of a coating layer.

As compared with the prior art, the present application has the following advantages: 1) the measurement can be realized by operating the pan handle only to enable the pan body to be inclined, and the operation is convenient to perform; by cooperatively using the first measuring mark and the second measuring mark to measure the oil amount, no measuring tool is needed to measure the oil amount, the oil amount can be relatively accurately controlled and the pan is simple and convenient to use; 2) the structure is simple and easy to realize and the pan with measuring marks is suitable for oil amount measurement of various pans such as flat-bottom pans and round-bottom pans; and 3) the first measuring mark and the second measuring mark can be provided by means of etching and laser, are not easily worn and are safe and effective to use.

### DESCRIPTION OF THE DRAWINGS

FIG. 1 illustrates a structural schematic diagram of embodiment 1 of the present application.

FIG. 2 illustrates a structural schematic diagram of embodiment 2 of the present application.

FIG. 3 illustrates a structural schematic diagram of embodiment 3 of the present application.

FIG. 4 illustrates a structural schematic diagram of embodiment 4 of the present application.

FIG. 5 illustrates a structural schematic diagram of embodiment 5 of the present application.

FIG. 6 illustrates a structural schematic diagram of embodiment 6 of the present application.

FIG. 7 illustrates a structural schematic diagram of embodiment 7 of the present application.

FIG. 8 illustrates a use state reference diagram of embodiment 2 of the present application.

FIG. 9 illustrates a structural schematic diagram of embodiment 8 of the present application.

FIG. 10 illustrates a structural schematic diagram of embodiment 9 of the present application.

In the drawings, 1—pan body; 2—pan handle; 3—first measuring mark; 4—second measuring mark; 5—oil

### DESCRIPTION OF THE EMBODIMENTS

The technical solutions of the embodiments of the present application will be explained and described below with reference to the drawings of the embodiments of the present application. However, the embodiments described below are just preferred embodiments of the present application instead of all embodiments of the present application. Other embodiments obtained by one skilled in the art based on the embodiments in the implementation modes without contributing any inventive labor shall be all included in the protective scope of the present application.

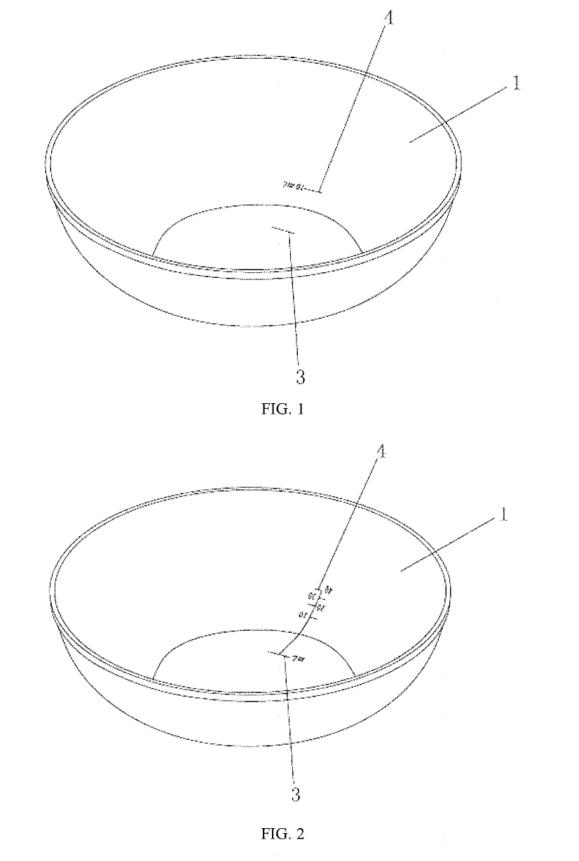

Referring to FIG. 1 to FIG. 10, a pan with measuring marks comprises a pan body and a pan handle mounted on the pan body; a first measuring mark is provided on a bottom surface of the pan body; a second measuring mark cooperatively used with the first measuring mark is provided on an inner sidewall of the pan body; and when the pan body is inclined, the measurement of oil amount is realized through the cooperative use of the first measuring mark and the second measuring mark.

Since the inner bottom surface and the inner sidewall of the pan body provided by the present application are respectively provided with the measuring marks, the measurement can be realized by operating the pan handle only to enable the pan body to be inclined, and the operation is convenient to perform; by cooperatively using the first measuring mark and the second measuring mark to measure the oil amount, no measuring tool is needed to measure the oil amount, the oil amount can be relatively accurately controlled and the pan is simple and convenient to use; the structure is simple and easy to realize and the pan with measuring marks is suitable for oil amount measurement of various pans such as flat-bottom pans and round-bottom pans; and the first measuring mark and the second measuring mark can be provided by means of etching and laser, are not easily worn and are safe and effective to use.

### Embodiment 1

As illustrated in FIG. 1, embodiment 1 of the present application is a pan with measuring marks, a pan handle 2 (not shown) is mounted on the pan body 1, a first measuring mark 3 is provided on an inner bottom surface of the pan body 1, the first measuring mark 3 is perpendicular to the pan handle 2, a second measuring mark 4 is provided on an inner sidewall of the pan body and the second measuring mark 4 is perpendicular to the pan handle 2. The first measuring mark 3 is a line segment and the second measuring mark 4 comprises a line segment and a measuring numerical value “10 mL” beside the line segment. When the pan body 1 is inclined, the measurement of the oil amount is realized through the cooperative use of the first measuring mark 3 and the second measuring mark 4. The first measuring mark 3 with the structure comprising the line segment is applicable to a round-bottom pan.

### Embodiment 2

As illustrated in FIG. 2, embodiment 2 of the present application is a pan with measuring marks, a pan handle 2 (not shown) is mounted on the pan body 1, a first measuring mark 3 is provided on an inner bottom surface of the pan body 1, the first measuring mark 3 is perpendicular to the pan handle 2, a plurality of second measuring marks 4 are provided on an inner sidewall of the pan body and the second measuring marks 4 are perpendicular to the pan handle 2. The first measuring mark 3 is a line segment and the second measuring marks 4 comprise a plurality of line segments and a plurality of measuring numerical values “10 mL”, “20 mL”, “30 mL” and “40 mL” beside the line segments. When the pan body 1 is inclined, the measurement of the oil amount is realized through the cooperative use of the first measuring mark 3 and the second measuring marks 4.

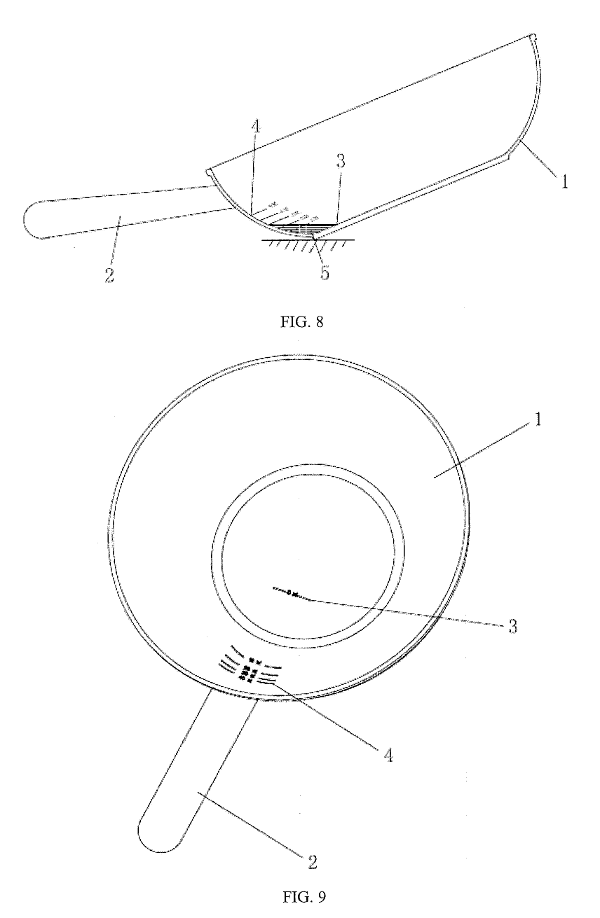

As illustrated in FIG. 8, when embodiment 2 of the present application is used, the pan handle 2 is operated on a vertical plane, the pan body 1 is inclined on the vertical plane to adjust the oil 5 in the pan body 1 to enable one side of the oil 5 to be in flush with the first measuring mark 3 on the inner bottom surface of the pan body 1, and when the oil is horizontal, the relative positions between the second measuring mark 4 on the inner sidewall of the pan body 1 and the oil surface are observed to obtain an approximate oil amount. The oil amount illustrated in FIG. 4 is 30 mL.

### Embodiment 3

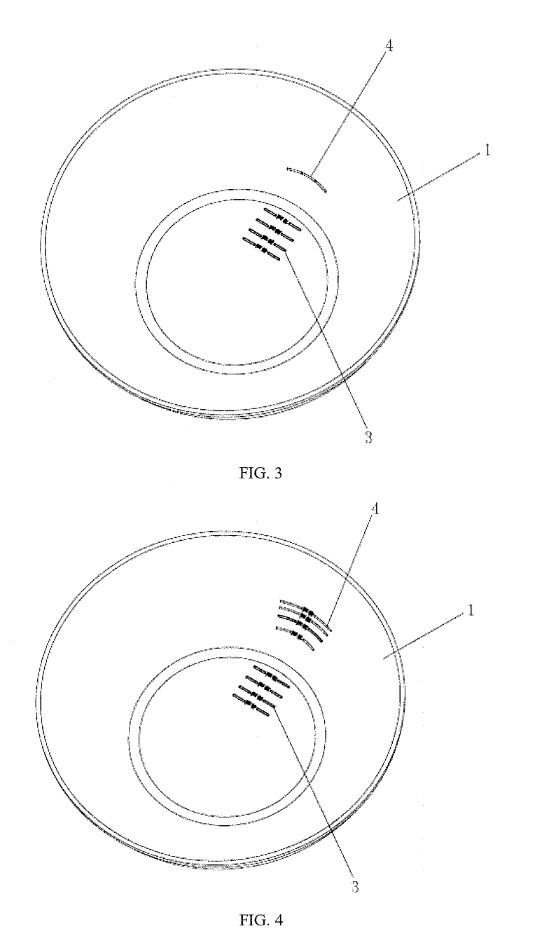

As illustrated in FIG. 3, embodiment 3 of the present application is a pan with measuring marks, a pan handle 2 (not shown) is mounted on the pan body 1, a plurality of first measuring marks 3 are provided on an inner bottom surface of the pan body 1, the first measuring marks 3 are perpendicular to the pan handle 2, a second measuring mark 4 is provided on an inner sidewall of the pan body and the second measuring mark 4 is perpendicular to the pan handle 2. The first measuring marks 3 comprise line segments and a plurality of measuring numerical values“10 mL”, “20 mL”, “30 mL” and “40 mL” in the middle of the line segments, the measuring numerical values break the line segments, and the second measuring mark 4 is an arc. When the pan body 1 is inclined, the measurement of the oil amount is realized through the cooperative use of the first measuring marks 3 and the second measuring mark 4.

### Embodiment 4

As illustrated in FIG. 4, embodiment 4 of the present application is a pan with measuring marks, a pan handle 2 (not shown) is mounted on the pan body 1, a plurality of first measuring marks 3 are provided on an inner bottom surface of the pan body 1, the first measuring marks 3 are perpendicular to the pan handle 2, a plurality of second measuring marks 4 are provided on an inner sidewall of the pan body and the second measuring marks 4 are perpendicular to the pan handle 2. The first measuring marks 3 comprise line segments and a plurality of measuring numerical values “10 mL”, “20 mL”, “30 mL” and “40 mL” in the middle of the line segments, the measuring numerical values break the line segments, the second measuring marks 4 comprise arcs and a plurality of measuring numerical values “10 mL”, “20 mL”, “30 mL” and “40 mL” in the middle of the arcs, and the measuring numerical values break the line segments. When the pan body 1 is inclined, the measurement of the oil amount is realized through the cooperative use of one first measuring mark 3 and one second measuring mark 4 corresponding thereto. Specifically, “10 mL” of the first measuring mark 3 is used as a reference, and when the oil surface corresponds to “10 mL” of the second measuring mark 4, the oil amount is 10 mL; and when the oil surface corresponds to “20 mL” of the second measuring mark 4, the oil amount is 20 mL.

### Embodiment 5

As illustrated in FIG. 5, embodiment 5 of the present application is a pan with measuring marks, a pan handle 2 (not shown) is mounted on the pan body 1, a plurality of first measuring marks 3 are provided on an inner bottom surface of the pan body 1, the first measuring marks 3 are perpendicular to the pan handle 2, a plurality of second measuring marks 4 are provided on an inner sidewall of the pan body, the second measuring marks 4 are perpendicular to the pan handle 2, and the first measuring marks 3 and the second measuring marks 4 form rings. The first measuring marks 3 comprise line segments and a plurality of measuring numerical values “10 mL”, “20 mL”, “30 mL” and “40 mL” above the middle of the line segments, and the second measuring marks 4 are arcs. When the pan body 1 is inclined, the measurement of the oil amount is realized through one ring formed by one measuring mark 3 and one second measuring mark 4 corresponding thereto.

### Embodiment 6

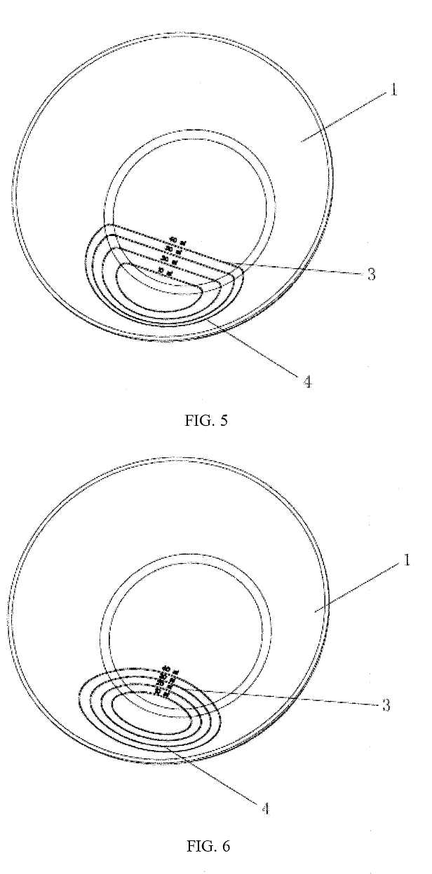

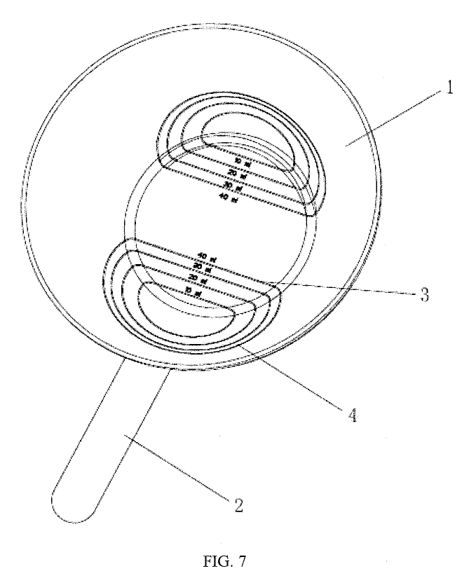

As illustrated in FIG. 6, embodiment 6 of the present application is a pan with measuring marks, a pan handle 2 (not shown) is mounted on the pan body 1, a plurality of first measuring marks 3 are provided on an inner bottom surface of the pan body 1, the first measuring marks 3 are perpendicular to the pan handle 2, a plurality of second measuring marks 4 are provided on an inner sidewall of the pan body, the second measuring marks 4 are perpendicular to the pan handle 2, and the first measuring marks 3 and the second measuring marks 4 form rings. The first measuring marks 3 comprise arcs and a plurality of measuring numerical values “10 mL”, “20 mL”, “30 mL” and “40 mL” above the arcs and the second measuring marks 4 are arc lines. When the pan body 1 is inclined, the measurement of the oil amount is realized through one ring formed by one measuring mark 3 and one second measuring mark 4 corresponding thereto. The first measuring marks 3 with the structure comprising the arcs are suitable for round-bottom pans.

### Embodiment 7

As illustrated in FIG. 7, embodiment 7 of the present application is a pan with measuring marks, a pan handle 2 is mounted on the pan body 1, a plurality of first measuring marks 3 are provided on an inner bottom surface of the pan body 1, the first measuring marks 3 are perpendicular to the pan handle 2, a plurality of second measuring marks 4 are provided on an inner sidewall of the pan body, the second measuring marks 4 are perpendicular to the pan handle 2, and the first measuring marks 3 and the second measuring marks 4 form rings. The first measuring marks 3 comprise line segments and a plurality of measuring numerical values “10 mL”, “20 mL”, “30 mL” and “40 mL” in the middle of the line segments and the second measuring marks 4 are arcs. When the pan body 1 is inclined, the measurement of the oil amount is realized through one ring formed by one measuring mark 3 and one second measuring mark 4 corresponding thereto. A plurality of first measuring marks 3 and a plurality of measuring marks 4 are provided at one end, close to the pan handle 2 and one end, far away from the pan handle 2, of the inner bottom surface of the pan body 1.

### Embodiment 8

As illustrated in FIG. 9, embodiment 8 of the present application is a pan with measuring marks, a pan handle 2 is mounted on the pan body 1, a first measuring mark 3 is provided on an inner bottom surface of the pan body 1, the first measuring mark 3 is perpendicular to the pan handle 2, a plurality of second measuring marks 4 are provided on an inner sidewall of the pan body, and the second measuring marks 4 are perpendicular to the pan handle 2. The first measuring mark 3 comprises a line segment and a reference measuring numerical value “10 mL” in the middle of the line segment. The second measuring marks 4 comprise a plurality of arcs and a plurality of measuring numerical values “10 mL”, “20 mL”, “30 mL” and “40 mL” at the arcs, the measuring numerical values break the arcs, plane on which the arcs are located are in parallel with one another, and the planes on which the arcs are located are in parallel with the bottom of the pan body. When the pan body 1 is inclined, the measurement of the oil amount is realized through one ring formed by one measuring mark 3 and one second measuring mark 4 corresponding thereto. The first measuring mark 3 and the second measuring marks 4 are formed by grooves in the pan body 1. The width of the grooves forming the line segment and the arcs is 0.3 mm and the depth is 0.3 mm. The width of the grooves forming the measuring numerical values is 0.1 mm and the depth is 0.3 mm. The grooves are coated with a coating layer.

### Embodiment 9

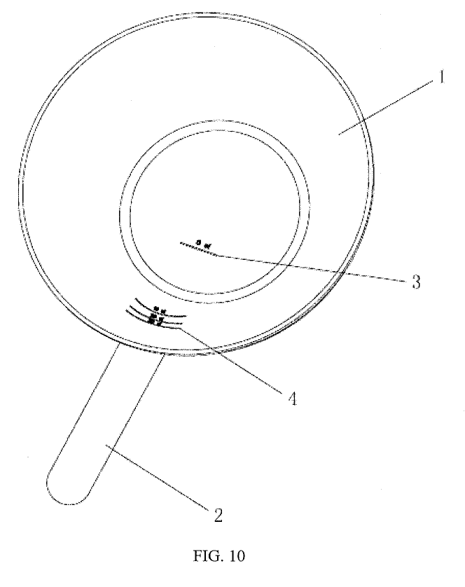

As illustrated in FIG. 10, embodiment 10 of the present application is a pan with measuring marks, a pan handle 2 is mounted on the pan body 1, a first measuring mark 3 is provided on an inner bottom surface of the pan body 1, the first measuring mark 3 is perpendicular to the pan handle 2, a plurality of second measuring marks 4 are provided on an inner sidewall of the pan body, and the second measuring marks 4 are perpendicular to the pan handle 2. The first measuring mark 3 comprises a line segment and a reference measuring numerical value “10 mL” in the middle of the line segment. The second measuring marks 4 comprise a plurality of arcs and a plurality of measuring numerical values “10 mL”, “20 mL”, “30 mL” and “40 mL” at the arcs, the measuring numerical values are located above the middle of the arcs, plane on which the arcs are located are in parallel with one another, and the planes on which the arcs are located are in parallel with the bottom of the pan body. The arc corresponding to each measuring numerical value is a complete arc and the measuring numerical value does not break the arc. When the pan body 1 is inclined, the measurement of the oil amount is realized through one ring formed by one measuring mark 3 and one second measuring mark 4 corresponding thereto. The first measuring mark 3 and the second measuring marks 4 are fainted by grooves in the pan body 1. The width of the grooves forming the line segment and the arcs is 0.5 mm and the depth is 0.5 mm. The width of the grooves forming the measuring numerical values is 0.1 mm and the depth is 0.5 mm.

What are described above are just specific implementation modes of the present application. However, the protective scope of the present application is not limited thereto. One skilled in the art shall understand that the present application includes but not limited to the content described in the drawings and the above-mentioned specific implementation modes. Any modifications made without departing from the functions and the structural principle of the present application shall be all included in the scope of the claims.

1. A pan with measuring marks comprising a pan body (1) and a pan handle (2) mounted on the pan body, wherein,
a first measuring mark (3) is provided on a bottom surface of the pan body;
a second measuring mark (4) cooperatively used with the first measuring mark (3) is provided on an inner sidewall of the pan body; and
when the pan body (1) is inclined, the measurement of oil amount is realized through the cooperative use of the first measuring mark (3) and the second measuring mark (4).

2. The pan with measuring marks according to claim 1, wherein the number of the first measuring mark (3) is one and the number of the second measuring mark (4) is one.

3. The pan with measuring marks according to claim 1, wherein the number of the first measuring mark (3) is one and the number of the second measuring mark (4) is more than one.

4. The pan with measuring marks according to claim 1, wherein the number of the first measuring mark (3) is more than one and the number of the second measuring mark (4) is one.

5. The pan with measuring marks according to claim 1, wherein the number of the first measuring mark (3) is more than one and the number of the second measuring mark (4) is more than one.

6. The pan with measuring marks according to claim 1, wherein the first measuring mark (3) and the second measuring mark (4) which are cooperatively used are provided with scale lines which are connected to form a ring.

7. The pan with measuring marks according to claim 1, wherein the first measuring mark (3) and the second measuring mark (4) are one or a combination of more of point, line, numeral, character and symbol.

8. The pan with measuring marks according to claim 1, wherein the first measuring mark (3) and the second measuring mark (4) are provided at a position, close to the pan handle (2), of the pan body (1).

9. The pan with measuring marks according to claim 3, wherein the pan body (1) is a flat-bottom circular pan body, the first measuring mark (3) comprises a line segment, the second measuring mark (4) comprises a plurality of arcs, planes on which the arcs are located are in parallel with one another and an Arabic numeral is provided at the position of each arc.

10. The pan with measuring marks according to claim 9, wherein the line segment and the arcs are formed by grooves on the pan body (1), the depth of each groove is smaller than or equal to 0.5 mm and the width of each groove is smaller than or equal to 0.5 mm.
